(19) United States
(12) Patent Application Publication
(10) Pub. No.: US 2012/0068420 A1
(43) Pub. Date: Mar. 22, 2012

(54) CENTERING METHOD FOR OPTICAL ELEMENTS

(75) Inventors: Baruch Ben-Menachem, Maale Adumin (IL); Mordechai Gilo, Rehovot (IL)

(73) Assignee: OPHIR OPTRONICS LTD., Jerusalem (IL)

(21) Appl. No.: 13/304,959

(22) Filed: Nov. 28, 2011

Related U.S. Application Data
(60) Provisional application No. 61/344,958, filed on Nov. 29, 2010.

(30) Foreign Application Priority Data
Mar. 28, 2010 (GB) 1105152.1

(51) Int. Cl. B23B 31/30; B23B 31/10

(52) U.S. Cl. 279/3; 279/126

(57) ABSTRACT

A method for centering a circular optical element using a non-self-centering chuck adapted to grip the element at two grip strengths. The element is rotated in the chuck while measuring the lateral position of the element's outer rim with a probe. The positions of maximum and minimum run-out of the element as a function of its angular position are determined. Chuck rotation is stopped at an angular position with the maximum rim run-out positioned at a predetermined point. The grip of the chuck is reduced such that the element is still held in the chuck but can be moved in a lateral direction without damaging its surface. The element is moved in a direction connecting the predetermined point of maximum run-out and the axis of rotation of the chuck, in order to reduce the run-out of the element. The procedure is repeated until the desired centering is achieved.

### RELATED APPLICATIONS

This application claims priority to United Kingdom Application No. 1105152.1, filed Mar. 28, 2010, and claims the benefit of U.S. Provisional Application No. 61/344958 filed Nov. 29, 2010. Each of these applications is herein incorporated by reference in their entirety for all purposes.

### FIELD OF THE INVENTION

The present invention relates to the field of the centering of optical elements for performing material processing steps on them, especially for use in diamond turning machines.

### BACKGROUND OF THE INVENTION

In order to generate precision optical surfaces on optical elements made of materials which can be removed by cutting actions rather than grinding, machining of the materials using a single point diamond tool is often the preferred method. Such diamond turning, as it is known in the art, can be used for generating complex spherical and non-spherical surfaces on such optical elements. The method utilizes highly accurate machine tools, which can provide surfaces having shape and smoothness compatible with the accuracy required of the optical elements. Because of the sensitivity of the process, special clamping methods have to be used for holding the elements in the machine, generally based on vacuum chucking.

An essential starting point for machining of any such optical element is that the element be accurately centered in the vacuum chuck, so that the optical axis of the generated optical form is correctly centered relative to the outer edge of the element, which is generally the reference edge used to mount the element in the final optical assembly. Therefore the centering of the element during diamond turning is a critical process, and the ability to perform this process in a minimum of time, and with high accuracy, yet without inflicting any damage on the sensitive optical surfaces of the element, is essential for the efficient production of such diamond turned elements. Furthermore, there is a need for the process to be automatic, in order to be compatible with the automatic turning of the element.

Current methods of centering elements for diamond turning are unsatisfactory with respect to these criteria. Current methods are generally non-automatic requiring manual operation by a skilled worker or, if automated, are damaging to the optical surface.

Prior art centering methods, both for use in metalworking machine tools and other applications, are described in U.S. Pat. No. 6,884,204, U.S. Pat. No. 6,767,407, US 2008/0164663, US 2007/0228673, JP 2003157589, JP 10043985, and in WO 2004/103638, the latter being for an optical method of centering. An exemplary vacuum chuck used for machining such elements is shown in U.S. Pat. No. 6,460,437 and continuations, assigned to the assignee of the present application.

There therefore exists a need for a centering method for use in optical diamond turning which overcomes at least some of the disadvantages of prior art systems and methods.

The disclosures of each of the publications mentioned in this section and in other sections of the specification, are hereby incorporated by reference, each in its entirety.

### SUMMARY OF THE INVENTION

The present disclosure describes a new exemplary system for the centering of optical elements relative to their outer edge in order to perform diamond turning of their surfaces. Because of the sensitive nature of the optical surfaces, it is important that the element is not subject to any lateral motion in a direction perpendicular to its optical axis while it is firmly clamped in its chuck. In such diamond turning machines, the chuck is usually a vacuum chuck which grips the element by generating a vacuum between the chuck body and the surface of the workpiece. The present system differs from such prior art systems, in that whereas the measurement of the lack of centricity is performed while the element is rotating, the centering action itself is performed only while the element is stationary. While the element is rotating, such as when machining it, the vacuum level is high, such that the chuck grips the element firmly. When it is desired to centre the element, the vacuum is reduced to a level such that the element is not firmly gripped, and centering action can move it without causing scratches on the optical surface. The degree of vacuum during the centering is dictated by the size and weight of the part, and lack of damage is verified by visual inspection of the part after turning. Any apparent damage can be reduced and eliminated by adjustment of the vacuum holding parameters.

The centering process is performed using the following components:
1. A chuck with variable holding force
2. A measuring gauge, with its measurement tip a known pre-measured distance from the rotation axis, that can measure the run-out of the element along an axis perpendicular to the rotation axis
3. A centering tool with its operating tip located at a known distance from the rotation axis, and which can move the element along that axis.

The measurement of the lack of centricity may be performed by a mechanical gauge, or any other suitably sensitive position sensor, such as an optical position probe, which tracks the lateral position along a predefined direction, most conveniently perpendicular to the axis of rotation, of the outer edge of the element as it rotates. The position sensor should be precalibrated such as by pre-measuring its distance from the chuck axis, such that its absolute position relative to the chuck axis is known. If the element is not centered, as it rotates the gauge shows a cyclic fluctuating reading between two extreme values representing the maximum and minimum run-out or throw of the element edge from the axis of rotation of the chuck. The lateral position measured of the edge of the element is correlated with the rotational angular position of the element. The control system determines the angular position associated with the point of maximum lateral run-out measured by the gauge, this position representing the angular position at which the outer edge of the element is furthest from the axis of rotation of the chuck. In order to correct this lateral offset, the element should be stopped with this angular position corresponding to the maximum lateral run-out aligned with a predetermined radial line, and the element moved laterally along that line towards the axis of rotation of the chuck by a distance of up to half of the difference between the maximum and minimum readings of the position gauge, this representing the departure from centricity of the element. In practice, this lateral motion may be performed by loosening the grip of the chuck on the element with the element stopped at the angular position of maximum run-out, and moving a centering tool along the direction of the predetermined radial line laterally towards the axis of rotation of the chuck until it touches the edge of the element, and from that point of touch, by an amount of up to half the difference between the maximum and minimum readings of the position sensor. The position of the centering tool is also precalibrated, such as by pre-measuring its tip distance from the chuck axis, so that its absolute position relative to the chuck axis is known. The point at which the centering tool just touches the edge of the element can be determined from the measurement of the run-off. The maximal edge position of the part and the runoff is measured by the probe. The amount of additional movement of the centering tool is given by the difference between the maximum and minimum readings of the position gauge, multiplied by a predefined factor (from 10% to 100%, but usually of the order of 70% or more, to provide rapid convergence of the centering process.

The grip on the element is again tightened, and the element rotated to determine whether it is now accurately centered. If the procedure has been well executed, the run-out should now be small, if at all present, and may generally be eliminated completely by another one or more centering routine procedures. In the above procedure, the movement of the centering tool is stated to be up to half the difference between the maximum and minimum readings of the position sensor. If an attempt is made to move the element in the first corrective step by exactly half of the difference between the maximum and minimum readings of the position gauge, in order to eliminate the lack of centricity in one iteration, there is a possibility that the correction motion will overshoot the optimum position, thus requiring a correction in the reverse direction, and possibly a series of incrementally decreasing corrections in opposite directions in order to converge on the true centered position. Therefore, it is generally advantageous not to attempt to exactly correct the run-out in the first correction step, but rather to make a correction movement of slightly less than half the offset distance, to avoid overshoot, and to converge on the position of exact centricity from one direction only, in iteratively decreasing steps. This method generally results in convergence with the minimum number of iterative steps. The amount of movement of the centering tool may be made relative to the run-out measurement. If, for instance, a level of 70% of the movement to eliminate the run-out is decided on as a suitable level, the inward motion of the centering tool is always made to be 70% of the last run-out elimination measurement, and that will cause positive convergence of the run-out to a minimum level, to less than the predetermined level desired. However, it is to be understood that the method is also implementable when it is attempted to achieve a movement of exactly half the distance difference, even if this may involve some overshoot. However, such an arrangement of moving the centering tool such that it moves the part to the pre-measured centered position, may result in a lack of convergence, and a longer procedure to obtain good centering.

In most diamond turning machines, the chuck is generally static, while the various cutting, measurement and centering tools move under machine control in the horizontal direction relative to the static chuck. However, it is to be understood that it is the relative motion between the tools and the workpiece in the chuck that is the operative motion in this invention. Therefore, this convention is not intended to limit the invention, and the invention is intended to be equally applicable if this order is reversed, with the tools etc., in a static position and the chuck moved under machine control.

One exemplary implementation involves a method for centering a circular optical element in a rotary, non-self-centering chuck, comprising:
(i) providing an optical element chuck, the chuck adapted to grip the optical element with at least two levels of grip,
(ii) rotating the optical element in the chuck while making measurements of the lateral position of the outer rim of the optical element with a distance measurement probe,
(iii) determining the positions of maximum and minimum run-out of the outer rim of the optical element as a function of the angular position of the optical element,
(iv) stopping the chuck rotation at an angular position such that the maximum rim run-out is positioned at a predetermined point,
(v) reducing the gripping power of the chuck such that the optical element is still held but can be moved in the chuck in a lateral direction without damaging its surface, and
(vi) moving the optical element in a direction connecting the predetermined point of maximum run-out and the axis of rotation of the chuck, in order to reduce the run-out of the optical element.

Yet other implementations perform a method as described above, wherein the optical element is moved either by a distance of up to half of the difference between the maximum and minimum run-out, or by a distance intended to be exactly half of the difference between the maximum and minimum run-out. Any of the above described methods may comprise the further step of repeating the centering method such that the centering is achieved more accurately.

In some implementations of this method, the chuck may be a vacuum chuck. Additionally, the optical element may be moved either by means of a centering tool, or by the measurement probe itself. In the latter case, the measurement probe may be equipped with a two level applied force mode, a first lower level for performing position measurements, and a second higher level for centering the element.

### BRIEF DESCRIPTION OF THE DRAWINGS

The presently claimed invention will be understood and appreciated more fully from the following detailed description, taken in conjunction with the drawings in which:

FIG. 1 illustrates schematically an exemplary optical element mounted in the vacuum chuck of a diamond turning machine, for performing the centering process;

FIGS. 2A to 2D illustrate the procedure by which the element is centered in the chuck of FIG. 1, according to an exemplary procedure described in this disclosure; and

FIG. 3 is a flow chart of an exemplary method of performing the centering process, as described in FIGS. 2A to 2D.

### DETAILED DESCRIPTION

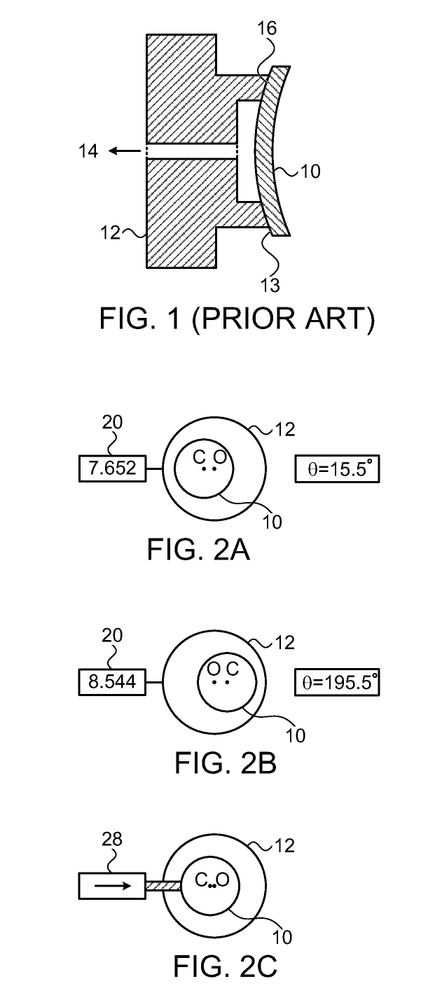

Reference is now made to FIG. 1, which illustrates schematically an exemplary optical element 10 mounted in the vacuum chuck 12 of a diamond turning machine. Since the chuck is not a self-centering device, the element when first mounted, will generally take up a non-centric position. In order to illustrate the manner in which the system and method described in this disclosure operate, the lack of centricity is exaggerated in FIG. 1, where the element 10 is shown to hang over 13 the bottom end of the chuck 16 seating face more than the top end. A common type of chuck used for such diamond turning of optical elements is a vacuum chuck, which grips the element by pulling its back surface onto a matching seating surface by means of a vacuum generated in passages 14 in the seating surface 16 of the chuck. When the vacuum is applied at its maximum value, up to 1 atmosphere, the element is firmly held in the chuck and can be machined by the diamond tool without moving. When the vacuum level is reduced, the element is held more loosely in the chuck, and under suitable level of grip, can be moved in the chuck without the chuck seating surface scratching the surface of the element.

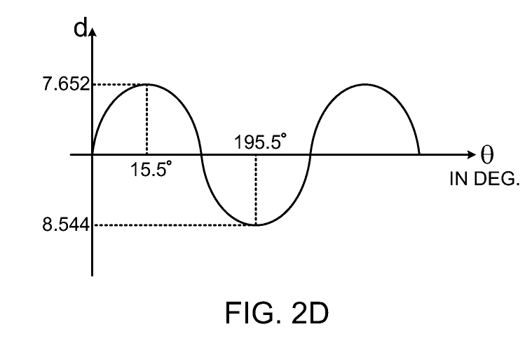

Reference is now made to FIGS. 2A to 2D, which illustrate the procedure by which the element is centered in the chuck according to an exemplary procedure described in this application. The chuck is rotated by the machine control, which keeps an accurate track of the angular position of the chuck. This angular position is illustrated on a display in FIGS. 2A to 2C, even though in practice, it is a data output generated by the machine control, which need not be physically displayed. The angular position is used by the centering system control in order to perform the centering. The rotation center of the chuck is marked as O in FIGS. 2A to 2C, while the optical center of the optical element is marked as C. A position measurement probe 20 is applied to the outer rim of the rotating optical element in order to track the run-out of the element as a function of angular position, as determined by the machine control. The position measurement probe 20 can be of any suitable type, such as a mechanical gauge, or an optical probe. The position measurement probe 20 generates an electrical signal corresponding to the distance measured, such that the output of the system as the element rotates is an electronic signal corresponding to the rim run-out as a function of angular position of the element. FIG. 2A shows the measurement probe contacting the rim of the element with the element in the position of maximum run-out. Reference is now made to FIG. 2D which shows a typical plot of the output of the position sensing probe as a function of angular position of the chuck. As is observed, as the element rotates, the distance probe shows a cyclic fluctuating output d, between two extreme values representing the maximum and minimum run-out or throw of the element edge from the axis of rotation of the chuck O. The rotation speed must be such that the distance sensor can respond sufficiently quickly to accurately follow the changes in run-out measured.

Reference is now made to FIG. 2B, which shows the probe contacting the rim of the element at the position of minimum run-out, which, if the element is round, should be rotated by 180° from the position shown in FIG. 2A. An exemplary position reading is shown next to the probe for each of these two positions. In the example shown, the difference between the shown readings 8.544 mm and 7.652 mm is 0.892 mm., while the angular readings of the position of maximum and minimum run-out are given as 15.5° and 195.5° respectively. It is possible to average these measurements over a number of cycles to average out any random deviations.

Reference is now made to FIG. 2C, which shows the next step of the centering operation. The chuck is stopped by the machine control with the point of maximum run-out, as known from the angular relationship shown in FIG. 2B, at a predetermined position. A centering tool 28 is disposed at this predetermined position. The vacuum grip of the chuck is then reduced so that the optical element can be moved without danger of scratching its seated surface, but not so much that the element falls out of the chuck. The axis of the rotating chuck is then moved under system control, until the centering tool 28 just touches the edge rim of the element, and is then moved towards the centering tool, in a line joining the predetermined position with the chuck rotation center, by a distance equal to up to half of the difference in readings of the maximum and minimum run-out determined in the step of FIG. 2B, in this example, half of 0.892 mm, this being 0.446 mm. The centering tool thus pushes the element a distance such that, if the measurements and corrections were absolutely accurate, the run-out should now be eliminated. The grip of the vacuum chuck can then be increased to its upper working value, and another check of the run-out performed using the distance probe. If the run-out is now beneath a predetermined threshold level, the centering can be assumed to be sufficiently good for machining the optical element, and the now accurately centered element turned or otherwise operated on in the machine.

In practice, since the first centering operation is not generally completely accurate, the run out measured is not beneath the desired threshold value, and a second or even further iterative centering cycles are performed, until any residual lack of centricity can be essentially completely eliminated.

Although the measurement probe and the centering tool are shown as separate elements, it is possible to adapt the measurement probe such that it can also function as the centering tool, such as by equipping it with two pressure levels of contact, a light contact to make the position measurements, and a heavier contact, such as at the mechanical end of the range of the measurement, to enter a fixed rigid mode for moving the part.

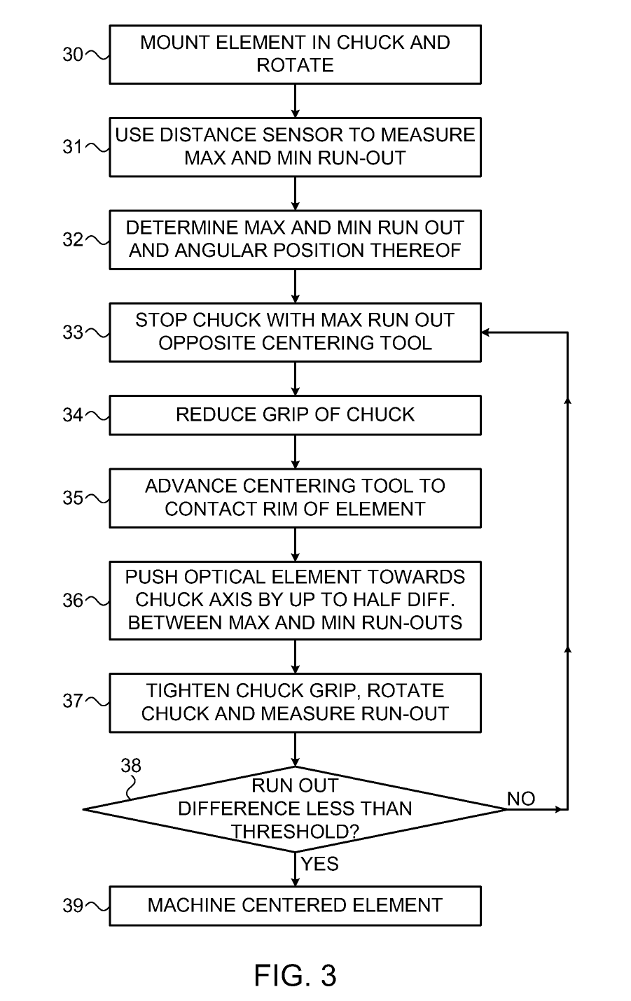

Reference is now made to FIG. 3 which is a flow chart of the above-described exemplary method of performing the centering process.

In step 30, the element is mounted in the chuck and is rotated.

In step 31, the position of the rim run-out as a function of angular position of the chuck is measured using the distance sensor.

In step 32, the maximum and minimum run-out values are determined, and the angular positions of the chuck at these values.

In step 33, the chuck is stopped with the position of maximum run-out disposed at a predetermined position opposite a linearly moveable centering tool.

In step 34, the chuck grip is relaxed so that the optical element can be pushed by the centering tool without scratching the seating surface of the element.

In step 35, the centering tool is advanced towards the vacuum chuck until the edge of the centering tool is in a position that it just touches the element at the point of maximum run-out.

In step 36, the centering tool is advanced towards the chuck axis by a distance of up to half the difference between the maximum and minimum run-out of the optical element.

In step 37, the chuck grip is again increased, and the optical element rotated therein, while the run-out is checked again.

In step 38, the difference between the maximum and minimum run-out is determined, and compared to a predetermined threshold level. If beneath the threshold level, control goes to step 39, where the centered optical element can be machined, as desired. If greater than the predetermined threshold level, the process returns to step 33, and a further round of position adjustment of the optical element is performed, until the centering is sufficiently good for the desired machining action.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

What is claimed is:

1. A method for centering a circular optical element in a rotary, non-self-centering chuck, comprising:
providing an optical element chuck, said chuck adapted to grip said optical element with at least two levels of grip;
rotating said optical element in said chuck while making measurements of the lateral position of the outer rim of said optical element with a distance measurement probe;
determining the positions of maximum and minimum run-out of said outer rim of said optical element as a function of the angular position of said optical element;
stopping said chuck rotation at an angular position such that the maximum rim run-out is positioned at a predetermined point;
reducing the gripping power of said chuck such that said optical element is still held but can be moved in said chuck in a lateral direction without damaging its surface; and
moving said optical element in a direction connecting said predetermined point of maximum run-out and the axis of rotation of said chuck, in order to reduce said run-out of said optical element.

2. A method according to claim 1, wherein said optical element is moved by a distance of up to half of the difference between said maximum and minimum run-out.

3. A method according to claim 1, wherein said optical element is moved by a distance intended to be exactly half of the difference between said maximum and minimum run-out.

4. A method according to claim 1, comprising the further step of repeating said centering method such that said centering is achieved more accurately.

5. A method according to claim 1, wherein said chuck is a vacuum chuck.

6. A method according to claim 1, wherein said optical element is moved by means of a centering tool.

7. A method according to claim 6, wherein said optical element is moved by the measurement probe itself.

8. A method according to claim 7, wherein said measurement probe is equipped with a two level applied force mode, a first lower level for performing position measurements, and a second higher level for centering said element.
